(19) United States
(12) Patent Application Publication
(10) Pub. No.: US 2013/0275286 A1
(43) Pub. Date: Oct. 17, 2013

(54) Computerized Method for Platinum Bond Financing By EB-5 Investor Visa Regional Center

(71) Applicant: Michael Lee Mattox, Lacey, WA (US)

(72) Inventor: Michael Lee Mattox, Lacey, WA (US)

(21) Appl. No.: 13/448,334

(22) Filed: Apr. 16, 2012

(51) Int. Cl. G06Q 40/06

(52) U.S. Cl. 705/37

(57) ABSTRACT

In some embodiments, a comprehensive computer system and method (See FIGS. 2, 3) for automating and facilitating the performing and processing of tasks, information transfer, and information storage associated with the financing through platinum bonds of EB-5 Investor Visa Regional Centers (or performing other business processes) over a distributed computing network are disclosed.

### BACKGROUND OF INVENTION

1. Field of the Invention

The invention relates generally to computer software. More specifically, the invention relates to a method for financing investments that meet the requirements of the United States government's EB-5 immigrant investor visa program.

2. Background Art

The United States Customs and Immigration Service (“USCIS”) administers the Immigrant Investor Program, also known as “EB-5,” created by Congress in 1990 to stimulate the U.S. economy through job creation and capital investment by foreign investors. Certain EB-5 visas are set aside for investors in regional centers designated by USCIS based on proposals for promoting economic growth. Regional centers may be any economic entity, public or private, which is involved with the promotion of economic growth, improved regional productivity, job creation, and increased domestic capital investment. Investments made through regional centers can take advantage of a more expansive concept of job creation, including both “indirect” and “direct” jobs.

The organizers of a regional center seeking the “Regional Center” (“RC”) designation from USCIS must submit a proposal, supported by economically or statistically valid forecasting tools, showing how the regional center plans to focus on a geographical region within the United States. The proposal must explain how the regional center will promote economic growth in that region, in verifiable detail (using economic models in some instances), jobs will be created directly or indirectly through capital investments made in accordance with the regional center's business plan. In addition, the proposed regional center must demonstrate the amount and source of capital committed to the regional center; the promotional efforts made and planned for the business project; and how the regional center will have a positive impact on the regional or national economy.

All EB-5 investors must invest in a commercial enterprise that will create or preserve at least 10 full-time jobs for qualifying U.S. workers within two years (or under certain circumstances, within a reasonable time after the two-year period) of the immigrant investor's admission to the United States as a Conditional Permanent Resident. Jobs created may be either direct or indirect jobs: Direct jobs are actual identifiable jobs for qualified employees located within the commercial enterprise into which the EB-5 investor has directly invested his or her capital, and indirect jobs are those jobs shown to have been created collaterally or as a result of capital invested in a commercial enterprise affiliated with a regional center by an EB-5 investor.

The minimum qualifying investment in the United States is $1 million, although the minimum qualifying investment either within a high-unemployment area or rural area in the United States is $500,000.

The economic models used to demonstrate the projected job creation impact and to prove actual job creation may be of any form, as long as they are recognized as legitimate models. As a result, for some time it has been known that computerized economic models such as RIMMS II and IMPLAN may serve this purpose. However, no one has addressed the complexities added by attempting to model and finance massive construction projects within the requirements of the EB-5 program, including the difficulty of identifying and describing the thousands of job positions created under dozens of contractors working on the projects, not to mention physically identifying associated federal tax documents relating to the same. Moreover, the complex task of handling the scores of instructions, transactions, storage functions, deliveries of funds and bonds, and record keeping entailed by the actual financing associated with such massive projects has not been addressed. All of these potential problems highlight the need for a method for platinum government bond financing by an EB-5 regional center that addresses the complexities of massive projects with extremely high levels of financing required, staggered issuing of bonds, multiple spending cycles, multiple sectors, and thousands of created jobs.

### SUMMARY OF INVENTION

The preferred embodiments of the invention provide, among other things, a computerized method for automating and facilitating the performing and processing of tasks, information transfer, and storage associated with the financing investments that meet the requirements of the United States government's EB-5 immigrant investor visa program.

Advantages of the present invention include providing a smoother, simpler, continuous process from the beginning to the end of the entire financing process; reducing work by all parties, allowing the process to be more highly automated, eliminating and reducing work currently being performed manually; reducing redundant and repetitive tasks of manually entering the same information numerous times in different computer programs, so information can be entered once for the entire transaction, not just portions of the transaction; allowing transaction information to be instantly available to immediately perform additional tasks anywhere in the process; reducing the cost of completing a transaction; reducing the number of personnel necessary to complete a transaction; and providing for greater reliability to be built into the process.

Other aspects and advantages of the invention will be apparent from the following description and the appended claims.

### BRIEF DESCRIPTION OF DRAWINGS

FIG. 1 shows a flow chart diagram of the method of the present invention.

FIG. 2 is a System Overview and Architecture Showing Ancillary Databases and Systems Detail for platinum bond financing by EB-5 investor visa regional center.

FIG. 3 is a System Overview and Architecture of a computerized method for platinum bond financing by EB-5 investor visa regional center.

FIG. 4 is a view depicting Basic Financing and Workflow Process.

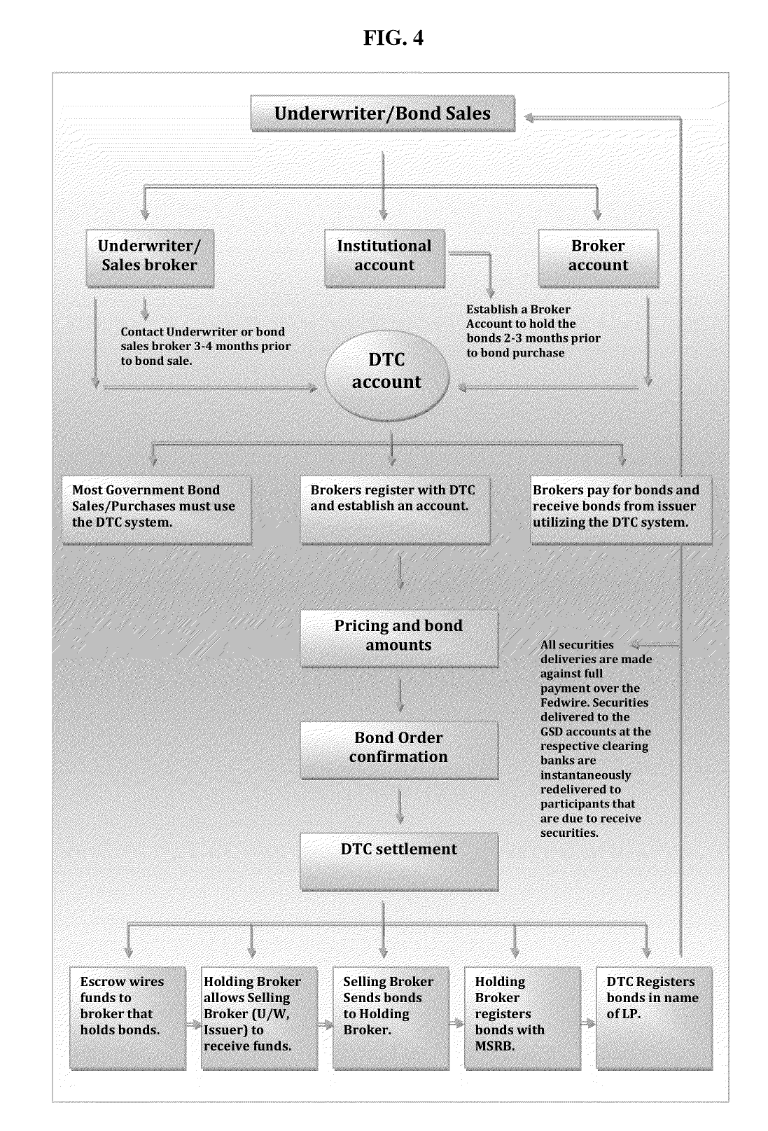

### DETAILED DESCRIPTION

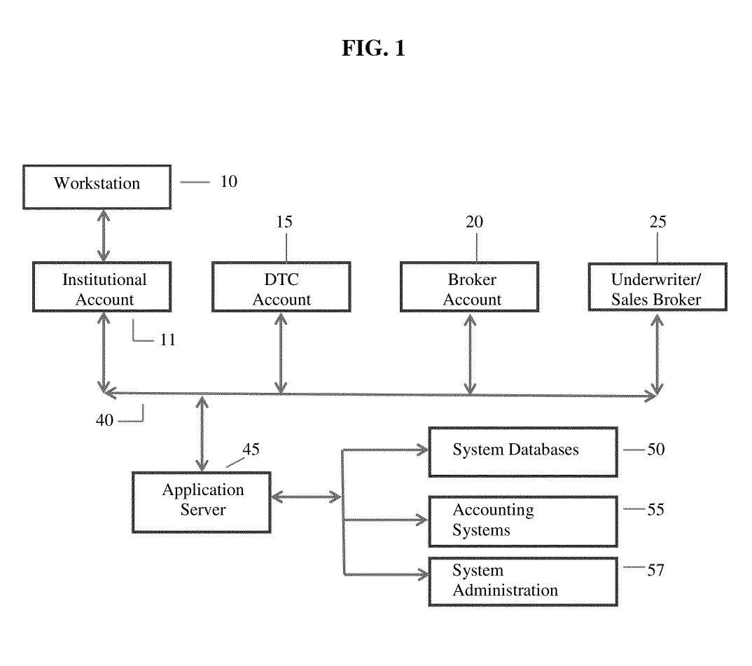

The present invention relates to a method for platinum government bond financing by an EB-5 regional center that addresses the complexities of massive projects with extremely high levels of financing required, staggered issuing of bonds, multiple spending cycles, multiple sectors, and thousands of jobs created over a distributed computing network (See FIG. 1).

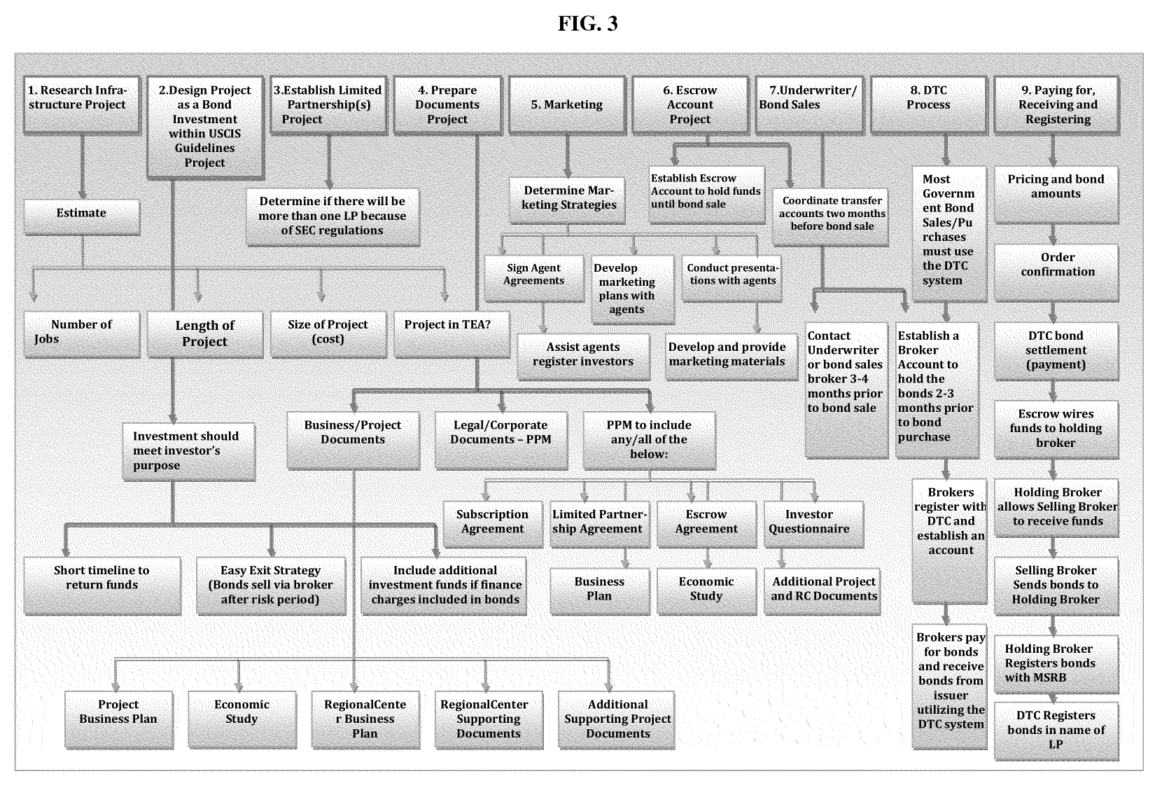

FIG. 3 shows a diagram of the method for platinum government bond financing 40. To better understand how the method 40 works, it is first necessary to understand typical electronic document structures. A compound file, such as an OLE/COM document, is actually an object-oriented collection of data streams. These streams are grouped together into storages. These storages can contain other storages in a hierarchical manner. The lowest level storage is called the root storage. The root storage contains all the information in the document and it is what we generally call the file.

When a document is embedded in another document, the embedded document's root storage becomes substorage in the parent document. The streams can be complex structures themselves, and are usually composed of multiple objects, which are themselves streams. For example, the Office Art layer introduced in Microsoft's Office 97® embeds drawing objects directly into the primary data stream of a Word document. The shape and inlineshape objects in Office Art are capable of storing images in file formats such as bitmaps, JPEGs, GIFs and PNGs, and other types of binary data. The shape and inlineshape objects are also the key to understanding compression techniques used in Office 2000® and Windows XP® versions. To parse the data in a compound file correctly, the file must be broken down into its elementary data streams. The elementary streams can be filtered and reassembled into a new document that is free of hidden data. It is important to note that compound files, such as OLE/COM, and other complex non-compound file types, like HTML and XML, are all handled in similar fashion by the DDE 64. FIG. 1 shows a flow chart of protocol in accordance with one embodiment of the present invention. In this embodiment, the method of utilizing government bonds for EB-5 Visa investment offerings begins with researching an appropriate infrastructure project. An estimate must be made regarding the proposed number of jobs; the length of the project; the cost of the project; and confirmation of whether the project is in a targeted employment area.

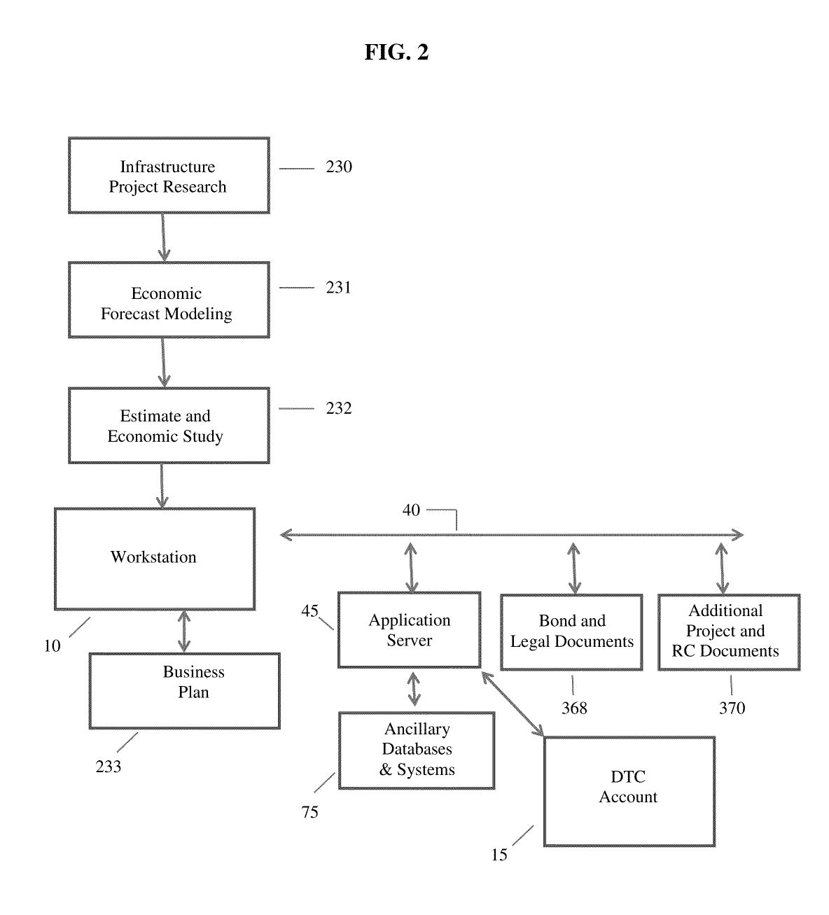

While the system may be implemented on one computer system such as a single personal computer, it is more likely to be implemented on a distributed computing network 40 (See FIGS. 1, 2). The distributed computing network 40 may be a local area network (LAN) or a wide area network (WAN), such as, for example, the Internet, a hard-wired or wireless network, or any combination thereof, and most likely will be implemented on the Internet or an Extranet.

One or more application servers 45 run computer program processes which perform the functions necessary to send and display screens to users to enter and view information, and perform their activities on remote, or local computing devices, receive information back from users, process it if necessary, store it in one or more databases 50, send it if necessary for use or processing by one or more ancillary systems or databases 75 (See FIG. 2) to perform necessary ancillary processes or activities, receive back results and save to one or more databases 75 (See FIG. 2), and make it available to all appropriate parties by again sending and displaying screens to users to view and perform subsequent activities on computing devices.

Although there are numerous computer technologies with which this computer process could be developed and carried out, the preferred embodiments of the invention provide a comprehensive client-and-server technology (See FIG. 2) allowing the users to use a personal computer (PC) workstation 10 with a display to view graphical user interfaces (GUI) screens, and common input devices, for example a mouse and keyboard, which access an application server(s) 45 over the Internet or over a secure “Extranet,” via TCP/IP. The application server(s) 45 would connect to one or more relational databases 50 (See FIG. 1) for transaction data to be saved and retrieved. These databases could be built in typical database programs such as, for example, SQL, DB2, and Oracle, and the application server process could be programmed in such tools as, for example, ASP and DOTNET programming environment from Microsoft, PeopleSoft's “Portal,” or IBM's “Domino,” “Websphere” and “Webspere Portal” in conjunction with using XML, JAVA, and HTML, or other programming tools. In addition, there may be one or more “ancillary” databases and systems 75 (See FIG. 2) with which the application server can exchange information. These “ancillary databases 75 may be developed with the system, or they may be provided by third parties, and accessed via programming tools such as, for example, XML.

The preferred embodiments and best mode of carrying out the invention are client-server architecture with one or more application servers 45 which run and manage the process. Actions taken by users on their client computer workstations 10 are processed by the application server 45 which processes information, performs tasks, serves up client user screens on computing devices, sends and retrieves information to and from databases or ancillary computer processes, and distributes information according to one or more application server programs to the workstation, managing and making the entire process possible.

The terms used hereinafter, such as for example “application,” “application server,” “computer program,” “computer process,” “computer application,” etc., are used interchangeably and deemed for the purposes of this application and claims to mean one or more computer applications performing the computer functions herein described unless otherwise indicated.

As described herein, in various embodiments, one or more server(s), client computer(s), application computer(s) and/or other computers can be utilized to implement one or more aspects of the invention. Illustrative computers can include, e.g. a central processing unit; memory (e.g. RAM, etc.) data storage (e.g., hard drives, etc.) input/output ports (e.g., parallel and/or serial ports, etc.); data entry devices (e.g. key boards, etc.); etc. In addition, client computers may contain, in come embodiments, browser software for interacting with the server(s), such as, for example, using hypertext transfer protocol (HTTP) to make requests of the server(s) via the Internet or the like.

The system may use one or more relational databases 50 (See FIG. 1) with a variety of structures which may include data categories such as, for example: regional center information, buyer information, sale information, etc.

While users may use any form of electrical computing device or general purpose computing machines or devices for accessing and interacting with the system 40, which could include personal computers, network terminals, digital Internet cell phones, palm pilots or telephone voice response or touch-tone technology, the description herein describes the use of a common personal computer with a display, a keyboard, and a pointing device such as a mouse. Electronic computing devices may also include any other suitable programmable electronic devices consistent with the invention.

It is pointed out that the order of steps or activities, and whether particular tasks are performed manually or automatically, is flexible and can be programmed to be varied to give the process and users as much flexibility as possible. In addition, various steps may be modified, simplified, and one or more tasks may be combined to simplify and streamline the overall process.

It is also pointed out that certain of the drawings herein reflect the “workflow” of the system, rather than the actual system architecture. In particular, FIG. 3 shows the process from start to finish, rather than the fact that all information, whether the result of user input or processes performed, in most cases is transferred to and from the application server(s) 45 and databases 50.

The first stage of the analysis brings in the element of human judgment and analysis: designing a project as a Bond Investment within USCIS Guidelines. From workstation 10, infrastructure project research 230 is directed toward finding an investment that meets the investor's purpose, provides a short timeline to return funds, has an easy exit strategy, such as having the bonds sell via broker after the risk period, and includes additional investment funds if finance charges will be included in the bonds. Economic forecast modeling 231 is employed to develop an economic study 232 and estimate 232 of costs and benefits of the proposed project.

Next is the establishment of a limited partnership(s) (“LP”) to own and manage the process. It must be determined if there will be more than one LP because of SEC regulations, and then documents 368 must be prepared. The business/project documents to be prepared include the Project Business Plan 233; the Economic Study 232; the Regional Center Business Plan 233; the Regional Center Supporting Documents 370; and any necessary additional supporting project documents 370.

In addition, legal/corporate documents 368 must be prepared, including those documents 369 necessary to register with the SEC and/or any applicable state financial institution as Registered Investment Advisors (RIA) or other venture, as required by law; a private placement memorandum (PPM) that may include a Subscription Agreement; Limited Partnership Agreement; Escrow Agreement; Investor Questionnaire; and any necessary additional project and RC documents. Marketing strategies must be determined; steps include signing agent agreements 370; determining marketing plans 370 with agents; conducting presentations 370 with agents; assisting agents with the registration of investors 370; and developing and providing marketing materials 370. In addition, an escrow account must be established to hold funds until the bond sale. Steps include coordinating transfer accounts two months before the bond sale; contacting an underwriter or bond sales broker 25 three to four months prior to the bond sale; establishing an institutional account 11 to purchase bonds; and establishing a broker account 20 to hold the bonds two to three months prior to bond purchase. The broker 25 must have a Depository Trust Company (“DTC”) account 15 (See FIG. 1), because most government bond sales/purchases must use the DTC system. The brokers 25 register with DTC and establish an account, paying for bonds and receiving bonds from an issuer utilizing the DTC system.

The Depository Trust Company (“DTC”), New York, N.Y., acts as securities depository for the Series 2012C Bonds. The Series 2012C Bonds will be issued as fully-registered securities registered in the name of Cede & Co. (DTC's partnership nominee) or such other name as may be requested by an authorized representative of DTC. One fully-registered Bond certificate will be issued for each maturity within a series of the Series 2012C Bonds in the principal amount of such maturity and will be deposited with DTC.

DTC, currently the world's largest depository, is a limited-purpose trust company organized under the New York Banking Law, a “banking organization” within the meaning of the New York Banking Law, a member of the Federal Reserve System, a “clearing corporation” within the meaning of the New York Uniform Commercial Code, and a “clearing agency” registered pursuant to the provisions of Section 17A of the Securities Exchange Act of 1934. DTC holds and provides asset servicing for over 3.5 million issues of U.S. and non-U.S. equity issues, corporate and municipal debt issues, and money market instruments (from over 100 countries) that DTC's participants (“Direct Participants”) deposit with DTC.

DTC also facilitates the post-trade settlement among Direct Participants of sales and other securities transactions in deposited securities, through electronic computerized book-entry transfers and pledges between Direct Participants' accounts. This eliminates the need for physical movement of securities certificates. Direct Participants include both U.S. and non-U.S. securities brokers and dealers, banks, trust companies, clearing corporations, and certain other organizations. DTC is a wholly-owned subsidiary of The Depository Trust & Clearing Corporation (“DTCC”). DTCC is the holding company for DTC, National Securities Clearing Corporation and Fixed Income Clearing Corporation, all of which are registered clearing agencies. DTCC is owned by the users of its regulated subsidiaries. Access to the DTC system is also available to others, such as both U.S. and non-U.S. securities brokers and dealers, banks, trust companies, and clearing corporations that clear through or maintain a custodial relationship with a Direct Participant, either directly or indirectly (“Indirect Participants”).

Purchases of Bonds under the DTC system must be made by or through Direct Participants, which will receive a credit for the Series 2012C Bonds on DTC's records. The ownership interest of each actual purchaser of each Bond (“Beneficial Owner”) is in turn to be recorded on the Direct and Indirect Participants' records. Beneficial Owners will not receive written confirmation from DTC of their purchase. Beneficial Owners are, however, expected to receive written confirmations providing details of the transaction, as well as periodic statements of their holdings, from the Direct or Indirect Participant through which the Beneficial Owner entered into the transaction. Transfers of ownership interests in the Series 2012C Bonds are to be accomplished by inputting into a terminal entries made on the books of Direct and Indirect Participants acting on behalf of Beneficial Owners. Beneficial Owners will not receive certificates representing their ownership interests in the Series 2012C Bonds, except in the event that use of the book entry system for the Series 2012C Bonds is discontinued.

To facilitate subsequent transfers, all Bonds deposited by Direct Participants with DTC are registered in the name of DTC's partnership nominee, Cede & Co., or such other name as may be requested by an authorized representative of DTC. The deposit of Bonds with DTC and their registration in the name of Cede & Co. or such other DTC nominee do not effect any change in beneficial ownership. DTC has no knowledge of the actual Beneficial Owners of the Series 2012C Bonds; DTC's records reflect only the identity of the Direct Participants to whose accounts such Bonds are credited, which may or may not be the Beneficial Owners. The Direct and Indirect Participants will remain responsible for keeping account of their holdings on behalf of their customers.

When notices are given, they are sent by the Bond Registrar to DTC only. Conveyance of notices and other communications by DTC to Direct Participants, by Direct Participants to Indirect Participants, and by Direct Participants and Indirect Participants to Beneficial Owners are governed by arrangements among them, subject to any statutory or regulatory requirements as may be in effect from time to time. Redemption notices are sent to DTC. If less than all of the Series 2012C Bonds within a Series are being redeemed, DTC's practice is to determine by lot the amount of the interest of each Direct Participant in such issue to be redeemed.

Neither DTC nor Cede & Co. (nor any other DTC nominee) consents or votes with respect to the Series 2012C Bonds unless authorized by a Direct Participant in accordance with DTC's MMI Procedures. DTC mails an Omnibus Proxy to the state as soon as possible after the record date. The Omnibus Proxy assigns Cede & Co.'s consenting or voting rights to those Direct Participants to whose accounts the Series 2012C Bonds are credited on the record date (identified in a listing attached to the Omnibus Proxy).

Payments on the Series 2012C Bonds will be made to Cede & Co., or such other nominee as may be requested by an authorized representative of DTC. DTC's practice is to credit Direct Participants' accounts upon DTC's receipt of funds and corresponding detail information from the state or the Bond Registrar, on payable date in accordance with their respective holdings shown on DTC's records. Payments by Participants to Beneficial Owners will be governed by standing instructions and customary practices, as is the case with securities held for the accounts of customers in bearer form or registered in “street name,” and will be the responsibility of such Participant and not of DTC, the Bond Registrar or the state, subject to any statutory or regulatory requirements as may be in effect from time to time. Payments to Cede & Co. (or any other nominee as may be requested by an authorized representative of DTC) are the responsibility of the state or the Bond Registrar, disbursement of such payments to Direct Participants will be the responsibility of DTC, and disbursement of such payments to the Beneficial Owners will be the responsibility of Direct and Indirect Participants.

DTC may discontinue providing its services as depository with respect to the Series 2012C Bonds at any time by giving reasonable notice to the state or the Bond Registrar. Under such circumstances, in the event that a successor depository is not obtained, Bond certificates are required to be printed and delivered. The state may decide to discontinue use of the system of book-entry-only transfers through DTC (or a successor securities depository). In that event, Bond certificates will be printed and delivered to DTC.

Finally, the steps of paying for, receiving, and registering bonds call for the selling broker to discuss pricing and bond amounts for the bond order, which is usually confirmed within one day. The amount of the bond settlement (payment) is determined in order to prepare for payment; next, the escrow wires the necessary funds to the broker that holds the bonds. The holding broker allows the selling broker, underwriter, and/or issuer to receive the funds; the selling broker then sends the bonds to the holding broker, who registers the bonds with the Municipal Securities Registration Board (MSRB). Ultimately, DTC registers the bonds in the name of the LP.

The information displayed to the user can be controlled through a configuration file. Some organizations may not be concerned about some data fields, such as the Author and Company fields in the meta data. This information could be removed from the user's display, which would make it easier for the user to concentrate on more important objects. The configuration file could also allow some automatic processing to occur. For example, correctly marked images could be automatically cropped and resized, or object linking and embedding (OLE) objects could be automatically converted, all without user intervention.

Examples of the present invention have been presented for use within the field of immigrant visa investor financing. However, it should be understood that the methods described could also be applied to other fields of finance.

While the invention has been described with respect to a single embodiment, those skilled in the art, having benefit of this disclosure, will appreciate that other embodiments can be devised which do not depart from the scope of the invention as disclosed here. Accordingly, the scope of the invention should be limited only by the attached claims.

1. A computer-implemented method of financing massive construction project investments that meet the requirements of the United States government's EB-5 immigrant investor visa program, the method comprising the steps of:
researching an infrastructure project;
designing a project as a bond investment within U.S. Customs and Immigration Services Guidelines;
establishing a limited partnership to manage the project;
registering with the U.S. Securities and Exchange Commission or state financial institution as Registered Investment Advisors or other venture, as required by law;
preparing documents necessary for the project;
marketing the project;
establishing an escrow account to hold funds until sale of bonds;
establishing a broker account to hold bonds;
establishing a Depository Trust Company account; and
purchasing, receiving and registering bonds.

2. A computer system to perform the financing of massive construction project investments that meet the requirements of the United States government's EB-5 immigrant investor visa program, comprising:
a first means for receiving and displaying financing criteria information comprising one or more of infrastructure research information, economic modeling information, business and project document information, marketing information, and funds and bond transaction information,
means for generating infrastructure research information,
means for generating economic modeling information,
means for generating business document information,
means for generating project document information,
means for generating marketing information,
means for generating bond pricing information,
means for performing fund transfers,
means for performing bond transfers,
means for communicating among said means for receiving and displaying financing criteria information, means for generating infrastructure research information, means for generating economic modeling information, means for generating business document information, means for generating project document information, means for generating marketing information, means for generating bond pricing information, means for performing fund transfers, and means for performing bond transfers,
means for sorting and organizing information,
said first means for receiving and displaying further receiving and displaying said infrastructure research information, economic modeling information, business document information, project document information, marketing information, and bond pricing information, wherein each of said infrastructure research information, economic modeling information, business document information, project document information, marketing information, and bond pricing information associated with said financing criteria information,
whereby a Regional Center searches for, markets, and finances with platinum bonds a massive infrastructure project that meets the requirements of the United States government's EB-5 immigrant investor visa program.

3. A computer-implemented commercial financial economic and investment development system establishing and operating economic development project investments that meet the requirements of the United States government EB-5 immigrant investor visa program, comprising:
a regional center directed to the promotion of economic growth, improved economic productivity in a region, job creation and increased capital investment, which regional center operates an economic development project financed by an investment within U.S. Customs and Immigration Services guidelines for EB-5 immigrant investor visa program;
a plurality of EB-5 capital investments each purchasing a portion of the investment issued by an entity established by the regional center for economic commercialization of the economic development project funded by the investment, each capital investment received from a respective one of a plurality of EB-5 investors that participate in the regional center;
a computer database accessible through a communications network connecting at least one workstation to receive, maintain, and display regional center and EB-5 investor information, including financing criteria information comprising one or more of infrastructure research information, economic modeling information, business and project document information, marketing information, and funds and investment transaction information;
an escrow account to hold capital investments of the EB-5 investors until sale of financial paper from the investment; and
an account to hold the financial paper in association with the respective EB-5 investor;
whereby EB-5 investors, being invested in the economic development project funded by the investment, receive an EB-5 immigrant visa.

4. The computer-implemented commercial financial economic and investment development system as recited in claim 3, wherein the investment issued by the entity comprises a bond investment and the financial paper comprises a bond.

5. The computer-implemented commercial financial economic and investment development system as recited in claim 4, further comprising an ownership transferor that receives instructions from a respective EB-5 investor to transfer the bond associated with said EB-5 investor to a subsequent beneficial owner.

6. The computer-implemented commercial financial economic and investment development system as recited in claim 4, further comprising a broker/dealer providing a bond account for holding, maintaining, and reporting bond records as to the EB-5 investors.

7. The computer-implemented commercial financial economic and investment development system as recited in claim 6, wherein the broker/dealer provides a depositor trust account for purchasing, receiving and registering bonds for the EB-5 investors.

8. The computer-implemented commercial financial economic and investment development system as recited in claim 3, wherein the regional center further comprises a marketer that markets the investment and the economic development project to a plurality of potential EB-5 investors.

9. The computer-implemented commercial financial economic and investment development system as recited in claim 3, wherein the regional center further comprises an operating entity for the economic development project that using the capital investments of the EB-5 investors to engage in the economic development project.

10. The computer-implemented commercial financial economic and investment development system as recited in claim 9, wherein the operating entity registers with appropriate government agencies for marketing of the investment for the economic development project to a plurality of potential EB-5 investors.

11. The computer-implemented commercial financial economic and investment development system as recited in claim 3, further comprises a document originator associated with the regional center for preparing legal and entity documents related to the regional center, the entity, and the economic development project.

12. The computer-implemented commercial financial economic and investment development system as recited in claim 11, wherein said legal and entity documents comprise EB-5 investor subscription agreement, entity organizing and operating agreements, investment escrow agreements and EB-5 investor questionnaire.

13. The computer-implemented commercial financial economic and investment development system as recited in claim 3, further comprises a document originator associated with the regional center for preparing business/project documents related to the regional center, the entity, and the economic development project.

14. The computer-implemented commercial financial economic and investment development system as recited in claim 11, wherein said business/project documents comprise a project business plan, an economic study, and a regional center business plan.
